(19) United States
(12) Patent Application Publication
(10) Pub. No.: US 2020/0185927 A1
(43) Pub. Date: Jun. 11, 2020

(54) CHARGING METHOD AND POWER SUPPLY DEVICE

(71) Applicant: I/O INTERCONNECT, LTD., Santa Ana, CA (US)

(72) Inventors: Gary KUNG, Santa Ana, CA (US); Tsung-Min Chen, Taipei (TW)

(21) Appl. No.: 16/215,835

(22) Filed: Dec. 11, 2018

(51) Int. Cl. H02J 7/00

(52) U.S. Cl. CPC H02J 7/007; H02J 7/0026

(57) ABSTRACT

A charging method, suitable for a power supply device connected to a power source and at least one power receiving device, is disclosed. The charging method includes the following operations: charging the at least one power receiving device by a battery of the power supply device and the power source if a power supply capability of the power source is smaller than charging demand of the at least one power receiving device; and charging the at least one power receiving device and the battery by the power source if the power supply capability of the power source is larger than the charging demand of the at least one power receiving device.

### FIELD OF INVENTION

The invention relates to a charging method and a power supply device. More particularly, the invention relates to a charging method and a power supply device for meeting the requirements of each device when multiple devices have simultaneous charging or power supply requirements.

### BACKGROUND

At present, under the specification of USB TYPE C, the power supply device usually outputs power according to the demand of the power receiving terminals. However, the power supply device may not satisfy the demand of several different power receiving terminals. Furthermore, the demand of the power receiving terminals may not by meet when the power supply capability of the power supply device is smaller than the demand of the power receiving terminals.

### SUMMARY

An embodiment of this disclosure is to provide a charging method, suitable for a power supply device connected to a power source and at least one power receiving device. The charging method includes the following operations: charging the at least one power receiving device by a battery of the power supply device and the power source if a power supply capability of the power source is smaller than charging demand of the at least one power receiving device; and charging the at least one power receiving device and the battery by the power source if the power supply capability of the power source is larger than the charging demand of the at least one power receiving device, in which the at least one power receiving device is connected to the power supply device.

An embodiment of this disclosure is to provide a power supply device includes a battery, a power receiving circuit, a loading detection circuit, a controller, and a power integration circuit. The power receiving circuit is configured to detect a power supply capability of a power source. The loading detection circuit is configured to detect charging demand of at least one power receiving device connected to the power supply device. The controller is configured to determine whether the power supply capability is smaller than the charging demand or not, and configured to determine whether the power supply capability is larger than the charging demand or not. When the power supply capability is smaller than the charging demand, the controller controls the power source and the battery to charge the at least one power receiving device together through the power integration circuit. When the power supply capability is larger than the charging demand, the controller controls the power source to charge the at least one power receiving device and the battery through the power integration circuit.

The embodiment of the present disclosure is to provide a charging method and a power supply device. More particularly, the invention relates to a charging method and a power supply device, so as to meet the demand of several power receiving devices with different charging or discharging demand. Furthermore, when the power supply capability of the power source is smaller than the demand of the power receiving devices, the demand of the power receiving devices may be meet by utilizing the battery of the power supply device and the power source at the same time.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a power supply device according to some embodiments of the present disclosure.

FIG. 2 is a schematic diagram illustrating a power supply device according to some embodiments of the present disclosure.

FIG. 3 is a schematic diagram illustrating a power integration circuit according to some embodiments of the present disclosure.

FIG. 4 is a flow chart illustrating a charging method according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

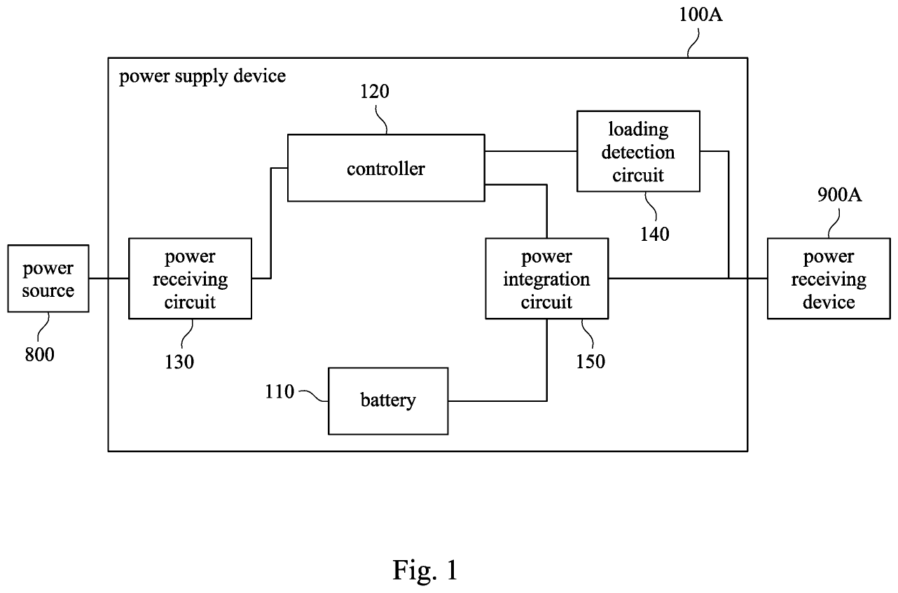

Reference is made to FIG. 1. FIG. 1 is a schematic diagram illustrating a power supply device 100A according to some embodiments of the present disclosure. As illustrated in FIG. 1, the power supply device 100A includes a battery 110, a controller 120, a power receiving circuit 130, a loading detection circuit 140, and a power integration circuit 150. The power supply device 100A may be connected to the power source 800 and the power receiving device 900A. The power supply device 100A shown in FIG. 1 is for illustrative purposes only and the present disclosure is not limited thereto.

In some embodiments, the power receiving circuit 130 is configured to detect a power supply capability of the power source 800. The loading detection circuit 140 is configured to detect charging demand of the power receiving device 900A. The controller 120 is configured to determine whether the power supply capability of the power source 800 is smaller than the charging demand of the power receiving device 900A or not. If the power supply capability of the power source 800 is smaller than the charging demand of the power receiving device 900A, the controller 120 controls to charge the power receiving device 900A by the power source 800 and the battery 110 at the same time through the power integration circuit 150.

The controller 120 is configured to determine whether the power supply capability of the power source 800 is larger than the charging demand of the power receiving device 900A or not. If the power supply capability of the power source 800 is larger than the charging demand of the power receiving device 900A, the controller 120 controls to charge the power receiving device 900A and the battery 110 by the power source 800 through the power integration circuit 150.

In some embodiments, if the power supply capability of the power source 800 is equal to the charging demand of the power receiving device 900A, the controller 120 controls to charge the power receiving device 900A and the battery 110 by the power source 800 through the power integration circuit 150.

For example, assume that the charging demand of the power receiving device 900A is 60 W (Watt) and the power supply capability of the power source 800 is 45 W. In this situation, the controller 120 determines that the power supply capability of the power source 800 is smaller than the charging demand of the power receiving device 900A. The controller 120 controls to charge the power receiving device 900A by the power source 800 and the battery 110 through the power integration circuit 150.

In some embodiments, the controller 120 further calculates the gap value between the power supply capability of the power source 800 and the charging demand of the power receiving device 900A, so as to control the power supplied by the battery 110. For example, when the charging demand of the power receiving device 900A is 60W and the power supply capability of the power source 800 is 45 W, the controller 120 calculates to obtain the gap value between the power supply capability of the power source 800 and the charging demand of the power receiving device 900A is 15 W. The controller further controls the battery 110 to charge the power receiving device 900A with supplied power of 15 W, so that when the power receiving device 900A is charged by the power source 800 and the battery 110 at the same time, the power receiving device 900A may receive a total power of 60 W.

For another example, assume that the charging demand of the power receiving device 900A is 30 W and the power supply capability of the power source 800 is 45 W. In this situation, the controller 120 determines that the power supply capability of the power source 800 is larger than the charging demand of the power receiving device 900A. The controller 120 controls to charge the power receiving device 900A and the battery 110 by the power source 800 and the battery 110.

In some embodiments, the controller 120 further calculates the gap value between the power supply capability of the power source 800 and the charging demand of the power receiving device 900A, so as to control the power supplied to the battery 110. For example, when the charging demand of the power receiving device 900A is 30 W and the power supply capability of the power source 800 is 45 W, the controller 120 calculates to obtain the gap value between the power supply capability of the power source 800 and the charging demand of the power receiving device 900A is 15 W. The controller further controls the power source to charge the battery 110 with a power of 15 W and to charge the power receiving device 900A with a power of 45 W.

In some embodiments, the controller 120 further determines whether the battery 110 is able to discharge or not. In some embodiments, when an electrical quantity of the battery 110 is higher than a quantity lower threshold, the controller 120 determines that the battery 110 is able to discharge. If the battery 110 is determined to be able to discharge, the battery 110 and the power source 800 are able to charge the power receiving device 900A at the same time.

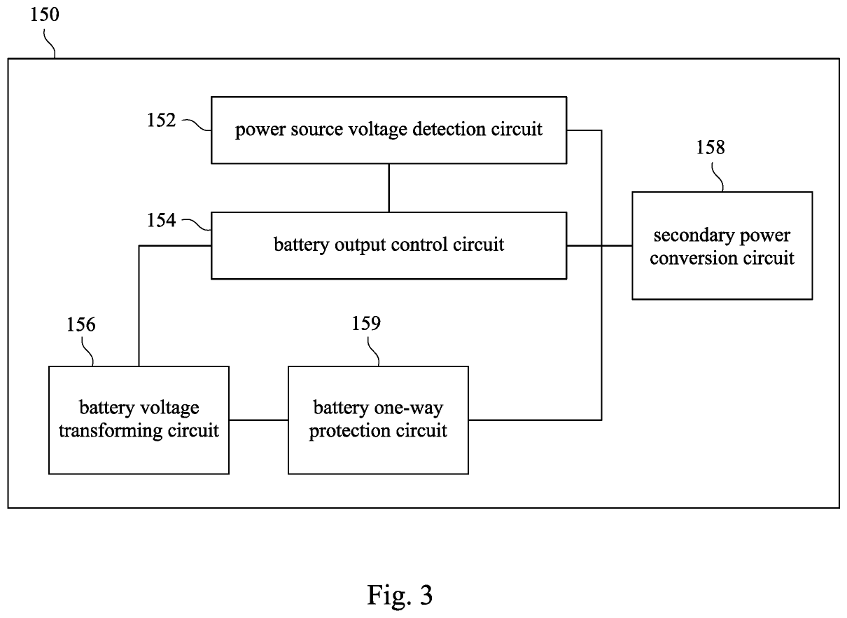

In some embodiments, the power integration circuit 150 is configured to integrate power of the battery 110 and power of the power source 800. The power integration circuit 150 is further configured to charge the power receiving circuit 900A after integration. For the operation of the power integration circuit 150, may be described in detail with FIG. 3 in the following.

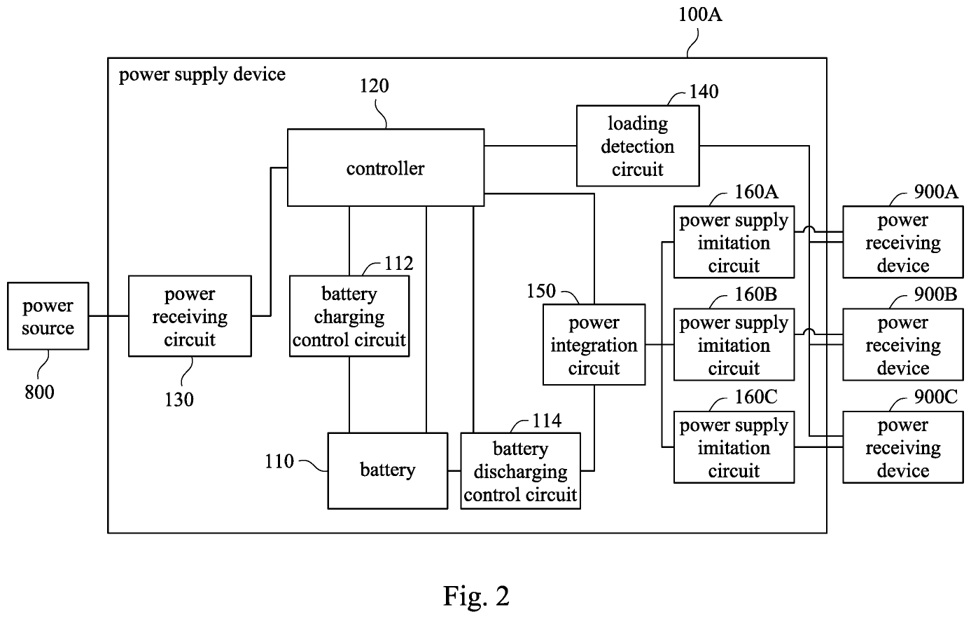

Reference is made to FIG. 2. FIG. 2 is a schematic diagram illustrating a power supply device 100B according to some embodiments of the present disclosure. The power supply device 100B shown in FIG. 2 is for illustrative purposes only and the present disclosure is not limited thereto.

As illustrated in FIG. 2, the power supply device 100B further comprises a battery charging control circuit 112 and a battery discharging control circuit 114. The battery charging control circuit 112 controls the charging of the battery 110, and the battery discharging control circuit 114 controls the discharging of the battery 110.

In some embodiments, when the battery 110 is unable to discharge, that is, when the electrical quantity of the battery 110 is lower than a quantity lower threshold, the controller 120 controls the battery charging control circuit 112 to charge the battery 110 by the power source 800. When the electrical quantity of the battery 110 becomes higher than a quantity upper threshold after charging, the controller 120 controls the battery charging control circuit 112 to stop charging the battery 110. At this time, if the charging demand of the power receiving device 900A is larger than the power supply capability of the power source 800, the controller 120 further controls the power source 800 and the battery 110 to charge the power receiving device 900A at the same time.

In some embodiments, when the electrical quantity of the battery 110 is lower than the quantity lower threshold after discharging, the controller 120 is further configured to control the battery discharging control circuit 114 to stop discharging the battery 110. The controller 120 is further configured to control the battery charging control circuit 112 to charge the battery 110 by the power source 800. It should be noted that if the charging capability of the power source 800 is smaller than the charging demand of the power receiving device 900A when the battery 110 stops discharging, the controller 120 controls the power integration circuit 150 to stop charging the power receiving device 900A.

In some embodiments, the power supply device 100B may be coupled to several power receiving devices 900A to 900C at the same time. Assume that the power receiving device 900A is the main power receiving device, and the power receiving device 900B to 900C are the secondary power receiving devices. In some embodiments, the controller 120 considers the charging demand of the main power receiving device prior to the charging demand of the secondary power receiving devices.

For example, assume that the charging demand of the power receiving device 900A is 60 W, the charging demand of the power receiving device 900B is 5 W, the charging demand of the power receiving device 900C is 10 W, the power supply capability of the power source 800 is 60 W, and the electrical quantity of the battery 110 is lower than the quantity lower threshold. In this situation, the controller 120 controls to charge the power receiving device 900A, which is the main power receiving device, with 60 W by the power source 800.

For another example, assume that the charging demand of the power receiving device 900A is 60 W, the charging demand of the power receiving device 900B is 5 W, the charging demand of the power receiving device 900C is 10 W, the power supply capability of the power source 800 is 45 W, and the electrical quantity of the battery 110 is lower than the quantity lower threshold. In this situation, since the power source 800 is unable to charge the power receiving device 900A, the controller 120 controls to charge the power receiving devices 900B and 900C, which are the secondary power receiving devices, with 15 W by the power source 800. The controller 120 further controls to charge the battery 110 with 30 W, which is the gap value between the power supply capability of the power source 800 and the sum of the charging demand of the power receiving devices 900B and 900C, by the power source 800.

In accordance with the above, assume that after the battery 110 is charged, the electrical quantity of the battery 110 becomes higher than the quantity upper threshold. At this time, the controller 120 controls to stop charging the battery 110. The controller 120 further controls the power source 800 and the battery 110 to charge the power receiving devices 900A to 900C. To be more detailed, the power provided by the power source 800 is 45 W, and the power provided by the battery 110 is 30V, so as to meet a total demand of 75V of the power receiving devices 900A to 900C.

For another example, assume that the charging demand of the power receiving device 900A is 45 W, the charging demand of the power receiving device 900B is 0 W, the charging demand of the power receiving device 900C 0 W, and the power supply capability of the power source 800 is 60 W. In this situation, the controller 120 controls to charge the power receiving devices 900A to 900C with 45 W, which is a total charging demand of the power receiving devices 900A to 900C, by the power source 800. The controller 120 further controls to charge the battery 110 with 15 W, which is the gap value between the power supply capability of the power source 800 and the sum of the charging demand of the power receiving devices 900A to 900C, by the power source 800.

In some embodiments, the power supply device 100B further comprises several power supply imitation circuits 160A to 160C, each of the power supply imitation circuits 160A to 160C corresponds to one of the power receiving devices 900A to 900C.

The power supply imitation circuits 160A to 160C are configured to imitate the power receiving devices 900A to 900C, so as to imitate the charging demand of the power receiving devices 900A to 900C and to provide corresponding power supply specifications. The power supply specifications include USB PD3.0, USB BC1.2, Apple Charging, but the present disclosure is not limited thereto.

Reference is made to FIG. 3. FIG. 3 is a schematic diagram illustrating a power integration circuit 150 according to some embodiments of the present disclosure. The power integration circuit 150 shown in FIG. 3 is for illustrative purposes only and the present disclosure is not limited thereto.

As illustrated in FIG. 3, the power integration circuit 150 includes a power source voltage detection circuit 152, a battery output control circuit 154, a battery voltage transforming circuit 156, and a secondary power conversion circuit 158. The power source voltage detection circuit 152 is configured to detect a voltage of the power source 800. The battery output control circuit 154 is configured to control the battery voltage transforming circuit 156 to transform a voltage of the battery 110 according to the voltage of the power source 800. The secondary power conversion circuit 158 is configured to integrate the voltage of the battery and the voltage of the power source and to transform the voltage received to a voltage suitable for the voltage of the power receiving devices 900A to 900C.

The power integration circuit 150 further includes a battery one-way protection circuit 159. The battery one-way protection circuit 159 is configured to protect the battery.

In some embodiments, the controller may collect information of the power source 800, the battery 110, and the power receiving devices 900A to 900C at predefined intervals, so as to adjust the charging/discharging of the battery 110 at intervals.

In accordance with the above, the power supply device 100A, 100B mentioning above controls to charge or discharge the battery 110 after comparing the power supply capability of the power source 800 and the charging demand of the power receiving devices 900A to 900C, so as to meet the demand of several power receiving devices 900A to 900C with different charging or discharging demand. Furthermore, when the power supply capability of the power source is smaller than the demand of the power receiving devices, the demand of the power receiving devices may be meet by utilizing the battery of the power supply device and the power source at the same time. Moreover, the battery 110 and the power receiving devices 900A to 900C may be charged at the same time.

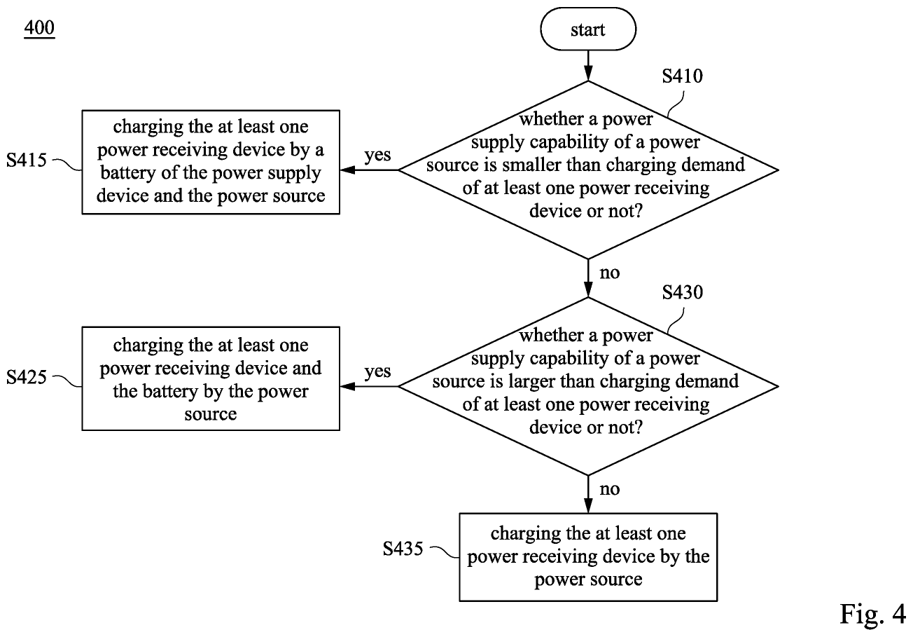

Reference is made to FIG. 4. FIG. 4 is a flow chart illustrating a charging method 400 according to some embodiments of the present disclosure. The charging method 400 includes operations S410-S445.

For convenience of explanation and understanding reference is made to FIG. 1, 2, and FIG. 4.

In operation S410, determining whether a power supply capability of a power source is smaller than charging demand of at least one power receiving device or not. In some embodiments, operation S410 may be performed by the controller 120, as illustrated in FIG. 1 and FIG. 2. For example, the controller 120 may collect information of the power supply capability from the power source 800 and information of the charging demand from the power receiving devices 900A to 900C. According to the information, the controller 120 determines whether the power supply capability of a power source 800 is smaller than charging demand of the power receiving devices 900A to 900C or not. If the power supply capability is smaller than the charging demand, operation S415 is performed. If the power supply capability is larger than the charging demand, operation S430 is performed.

In operation S430, determining whether a power supply capability of a power source is larger than charging demand of at least one power receiving device or not. In some embodiments, operation S430 may be performed by the controller 120, as illustrated in FIG. 1 and FIG. 2. For example, the controller 120 may collect information of the power supply capability from the power source 800 and information of the charging demand from the power receiving devices 900A to 900C. According to the information, the controller 120 determines whether the power supply capability of a power source 800 is larger than charging demand of the power receiving devices 900A to 900C or not. If the power supply capability is larger than the charging demand, operation S425 is performed. If the power supply capability is larger than the charging demand, operation S435 is performed.

In operation S415, charging the at least one power receiving device by a battery of the power supply device and the power source. In some embodiments, operation S415 may be performed by the controller 120 and the power integration circuit 150, as illustrated in FIG. 1 and FIG. 2. For example, when the power supply capability of the power source 800 is smaller than the charging demand of the power receiving devices 900A to 900C, the controller 120 may control the power source 800 and the battery 110 to charge the power receiving devices 900A to 900C through the power integration circuit 150 at the same time.

In some embodiments, operation S415 further includes the operation of determining whether the battery 110 is able to discharge or not. Whether the battery 110 is able to discharge or not is determined by the electrical quantity of the battery 110. That is, when the electrical quantity of the battery 110 is higher than a quantity lower threshold, it is determined that the battery is able to discharge.

In some embodiments, operation S415 further includes the operations of stop discharging the battery 110 if an electrical quantity of the battery 110 is lower than a quantity lower threshold, and controlling the battery charging control circuit 112 to charge the battery 110 by the power source 800. That is, after the battery 110 discharges for a period of time, the electrical quantity of the battery 110 becomes lower than the quantity lower threshold. At this time, the controller 120 stops discharging the battery 110. The controller 120 further controls the battery charging control circuit 112 to charge the battery 110 by the power source 800.

In operation S425, charging the at least one power receiving device and the battery by the power source. In some embodiments, operation S425 may be performed by the controller 120, as illustrated in FIG. 1 and FIG. 2. For example, when the power supply capability of the power source 800 is larger than the charging demand of the power receiving devices 900A to 900C, the controller 120 may control the power source 800 to charge the power receiving devices 900A to 900C and the battery 110 at the same time.

In some embodiments, operation S425 further includes the operations of stop charging the battery 110 when an electrical quantity of the battery 110 is higher than a quantity upper threshold, and controlling the battery discharging control circuit 114, as illustrated in FIG. 2, to discharge the battery 110. That is, if the battery 110 is unable to discharge at first, the controller 120 may control the power source 800 to charge the battery 110. When the electrical quantity of the battery 110 becomes higher than the quantity upper threshold, the controller 120 controls to stops charging the battery 110. The controller 120 further controls the battery discharging control circuit 114 to discharge the battery 110, so as to charge the power receiving devices 900A to 900C.

In operation S435, charging the at least one power receiving device by the power source. In some embodiments, operation S435 may be performed by the controller 120, as illustrated in FIG. 1 and FIG. 2. For example, when the power supply capability of the power source 800 is equal to the charging demand of the power receiving devices 900A to 900C, the controller 120 may control the power source 800 to charge the power receiving devices 900A to 900C.

In some embodiments, charging method 400 further includes the operations of determining whether the power receiving devices 900A to 900C exists or not, and charging the battery 110 by the power source 800 if the power receiving devices 900A to 900C do not exist. That is, the controller 120 considers the charging demand of the power receiving devices 900A to 900C first. If none of the power receiving devices 900A to 900C exists, the battery 110 may then be charged by the power source 800.

In some embodiments, charging method 400 further includes the operations of determining whether the power supply device 100A or 100B is connected to the power source 800 or not, and charging the power receiving devices 900A to 900C if the power supply device 100A or 100B is not connected to the power source 800. That is, if the power supply device is not connected to the power source, the power receiving devices 900A to 900C may only be charged by the battery 110.

In some embodiments, the quantity upper threshold is 80% of the total electrical quantity of the battery 110. In some embodiments, the quantity lower threshold is 0% of the total electrical quantity of the battery 110. The quantity upper threshold and the quantity lower threshold mentioning above are for illustrative purposes only, and the present disclosure is not limited thereto.

In some embodiments, the power supply device 100A or 100B may be a device or a circuit with the function of power supplying and/or power receiving or other equivalent functions. In some embodiments, the controller 120 may be a circuit or an element with the function of calculating, controlling, information or message receiving/transmitting or other equivalent functions.

In some embodiments the battery 110 may be a circuit or an element with the function of power saving, power receiving, and/or power providing, or other equivalent functions. In some embodiments, the power receiving circuit 130 may be a circuit or an element with the function of power receiving and/or power source specification detecting, or other equivalent functions.

In some embodiments, the power integration circuit 150 may be a circuit or an element with the function of power integration or other equivalent function. In some embodiments, the loading detection circuit 140 may be a circuit or an element with the function of load detection or other equivalent functions.

According to the embodiment of the present disclosure, it is understood that the embodiment of the present disclosure is to provide a charging method and a power supply device. More particularly, the invention relates to a charging method and a power supply device, so as to meet the demand of several power receiving devices with different charging or discharging demand. Furthermore, when the power supply capability of the power source is smaller than the demand of the power receiving devices, the demand of the power receiving devices may be meet by utilizing the battery of the power supply device and the power source at the same time.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A charging method, suitable for a power supply device connected to a power source and at least one power receiving device, the charging method comprising:
charging the at least one power receiving device by a battery of the power supply device and the power source if a power supply capability of the power source is smaller than charging demand of the at least one power receiving device; and
charging the at least one power receiving device and the battery by the power source if the power supply capability of the power source is larger than the charging demand of the at least one power receiving device.

2. The charging method of claim 1, further comprising:
determining whether the battery is able to discharge or not when the power supply capability of the power source is smaller than the charging demand of the at least one power receiving device.

3. The charging method of claim 2, wherein when an electrical quantity of the battery is higher than a quantity lower threshold, it is determined that the battery is able to discharge.

4. The charging method of claim 1, further comprising:
stopping charging the battery when an electrical quantity of the battery is higher than a quantity upper threshold.

5. The charging method of claim 4, further comprising:
controlling the battery discharging control circuit to discharge the battery.

6. The charging method of claim 1, further comprising:
stopping discharging the battery if an electrical quantity of the battery is lower than a quantity lower threshold.

7. The charging method of claim 6, further comprising:
controlling the battery charging control circuit to charge the battery by the power source.

8. The charging method of claim 1, further comprising:
determining whether the at least one power receiving device exists or not; and
charging the battery by the power source if the at least one power receiving device does not exist.

9. The charging method of claim 1, further comprising:
determining whether the power supply device is connected to the power source or not; and
charging the at least one power receiving device by the battery if the power supply device is not connected to the power source.

10. A power supply device, comprising:
a battery;
a power receiving circuit, configured to detect a power supply capability of a power source;
a loading detection circuit, configured to detect charging demand of at least one power receiving device connected to the power supply device;
a controller, configured to determine whether the power supply capability is smaller than the charging demand or not, and configured to determine whether the power supply capability is larger than the charging demand or not; and
a power integration circuit;
wherein when the power supply capability is smaller than the charging demand, the controller controls the power source and the battery to charge the at least one power receiving device together through the power integration circuit;
wherein when the power supply capability is larger than the charging demand, the controller controls the power source to charge the at least one power receiving device and the battery through the power integration circuit.

11. The power supply device of claim 10, wherein the controller further determines whether the battery is able to discharge or not.

12. The power supply device of claim 11, wherein when an electrical quantity of the battery is higher than a quantity lower threshold, the controller determines that the battery is able to discharge.

13. The power supply device of claim 10, wherein when an electrical quantity of the battery is higher than a quantity upper threshold, the controller is further configured to control a battery charging control circuit to stop charging the battery.

14. The power supply device of claim 13, wherein the controller is further configured to control a battery discharging control circuit to discharge the battery.

15. The power supply device of claim 10, wherein when an electrical quantity of the battery is lower than a quantity lower threshold, the controller is further configured to control a battery discharging control circuit to stop discharging the battery.

16. The power supply device of claim 15, wherein the controller is further configured to control a battery charging control circuit to charge the battery by the power source.

17. The power supply device of claim 10, further comprising:
at least one power supply imitation circuit, configured to imitate the at least one power receiving device.

18. The power supply device of claim 10, wherein the power integration circuit is configured to integrate power of the battery and power of the power source, and configured to charge the at least one power receiving circuit after integration.

19. The power supply device of claim 18, wherein the power integration circuit further comprises:
a power source voltage detection circuit, configured to detect a voltage of the power source;
a battery voltage transforming circuit;
a battery output control circuit, configured to control the battery voltage transforming circuit to transform a voltage of the battery according to the voltage of the power source; and
a secondary power conversion circuit, configured to integrate the voltage of the battery and the voltage of the power source.

20. The power supply device of claim 19, further comprising:
a battery one-way protection circuit, configured to protect the battery.
